(19) United States
(12) Patent Application Publication
(10) Pub. No.: US 2016/0324250 A1
(43) Pub. Date: Nov. 10, 2016

(54) ELECTRICITY GENERATING SHOES

(71) Applicant: Auspring Co., Ltd., Taipei City (TW)

(72) Inventors: Shui-Ching Lin, Taipei City (TW); Pao-Tien Chao, New Taipei City (TW)

(21) Appl. No.: 14/705,044

(22) Filed: May 6, 2015

(51) Int. Cl. A43B 3/00; F03G 5/06; H02K 7/18

(52) U.S. Cl. CPC A43B 3/0015; H02K 7/1853; F03G 5/06

(57) ABSTRACT

An electricity shoe is disclosed, comprising a shoe body, comprising a shoe bottom, a heel disposed movably on the shoe bottom, and a shoe top-face disposed on a top face of the shoe bottom; an electricity mechanism, disposed at the heel of the show body and driven by the heel; and a chargeable battery, disposed within the shoe bottom and connected movably to the electricity generating mechanism. As such, an electricity generating mechanism may be driven by a heel portion of the shoe when a user wears and walks on the shoe, so that the electricity generating mechanism charges a chargeable battery and the efficacies of charging without requiring a power, energy saving and environmental protection may be achieved.

### FIELD OF THE INVENTION

The present invention relates to an electricity shoe, and particularly to an electricity generating shoe, on which an electricity generating mechanism may be driven by a heel portion of the shoe when a user wears and walks on the shoe, so that the electricity generating mechanism charges a chargeable battery and the efficacies of charging without requiring a power, energy saving and environmental protection may be achieved.

### DESCRIPTION OF THE RELATED ART

On the course of charging a conventional chargeable battery, the chargeable battery has to be placed on a particular charger, and then the charger is inserted and connected to a commercial power. However, since the commercial power is required for the conventional charging task, it is impossible for a user to enjoy a quick charging convenience on a condition without the commercial power. Further, although the chargeable battery may be repeatedly used after being charged by the commercial power, whether such charging fashion also secure energy saving and environmental protection.

Therefore, the inventor of the present invention sets forth an electricity generating shoe to effectively improve the shortcoming encountered in the prior art.

### SUMMARY OF THE INVENTION

It is, therefore, an object of the present invention to provide an electricity generating shoe, on which an electricity generating mechanism may be driven by a heel portion of the shoe when a user wears and walks on the shoe, so that the electricity generating mechanism charges a chargeable battery and the efficacies of charging without requiring a power and energy saving and environmental protection may be achieved.

It is, therefore, an object of the present invention to provide an electricity generating shoe, on which an electricity generating mechanism may be driven by a heel portion of the shoe when a user wears and walks on the shoe, so that the electricity generating mechanism charges a chargeable battery and the efficacies of charging without requiring a power and energy saving and environmental protection may be achieved.

According to the present invention, the electricity shoe comprises a shoe body, comprising a shoe bottom, a heel disposed movably on the shoe bottom, and a shoe top-face; an electricity mechanism, disposed at the heel of the show body and driven by the heel; and a chargeable battery, disposed within the shoe bottom and connected movably to the electricity generating mechanism.

In an embodiment, the heel has a tooth bar connected to the electricity generating mechanism and the shoe bottom has a reception area combined with the chargeable battery.

In an embodiment, the electricity mechanism comprises a transmission unit connected to the heel, a generator connected to the transmission unit, a rectifier connected to the generator, a switch connected to the rectifier, and a connector disposed within the reception area and connected to the switch, wherein the chargeable battery is connected movably to the connector.

In an embodiment, transmission unit has a first gear portion and a second gear portion disposed thereon, wherein the first gear portion is mated with the tooth bar, and a driving gear is disposed on the generator to mate with the second gear portion.

In an embodiment, the chargeable battery is selected from a group consisting of a lithium chargeable battery, a solid state chargeable battery, and a paper chargeable battery.

In an embodiment, the chargeable battery further has a connector disposed thereon. BRIEF DESCRIPTIONS OF THE DRAWINGS

The present invention will be better understood from the following detailed descriptions of the preferred embodiments according to the present invention, taken in conjunction with the accompanying drawings, in which:

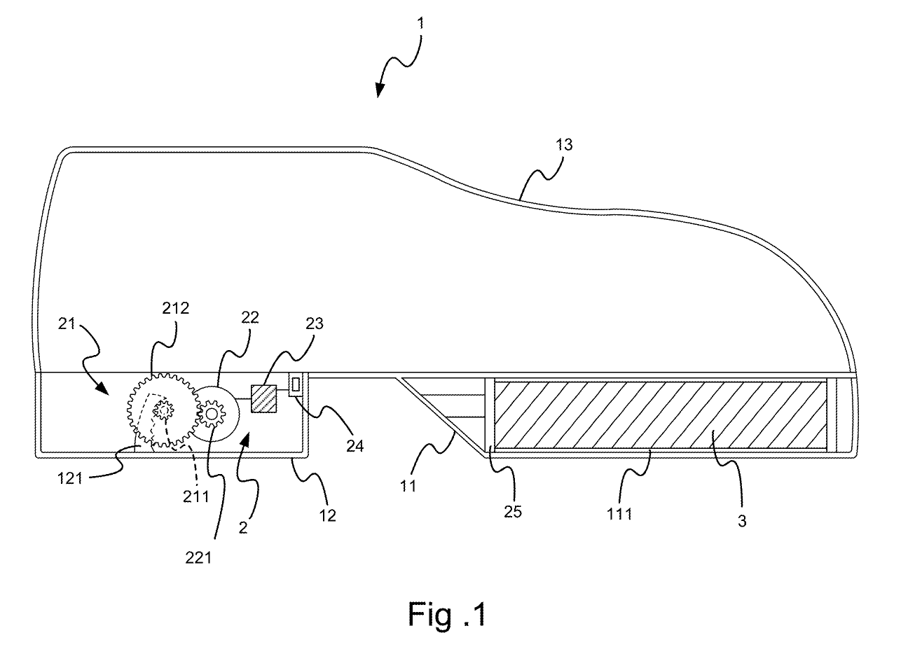

FIG. 1 is a schematic diagram of a cross sectional view according to the present invention.

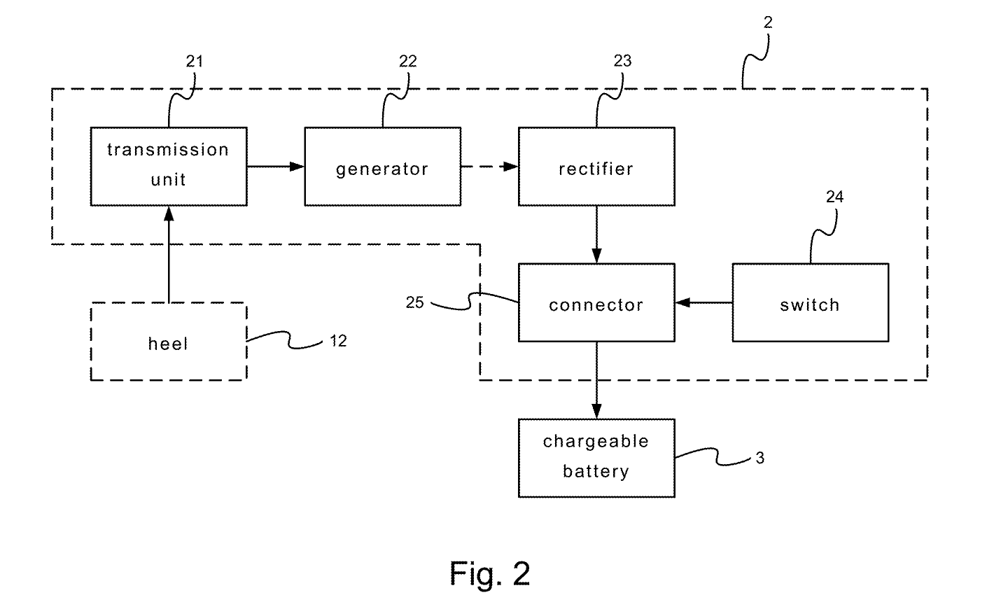

FIG. 2 is a schematic block diagram according to the present invention.

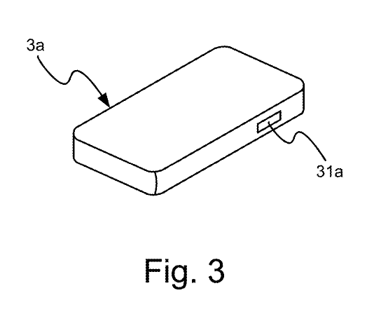

FIG. 3 is a schematic diagram of a chargeable battery according to another embodiment of the present invention.

### DESCRIPTION OF THE PREFERRED EMBODIMENTS

Referring to FIG. 1 and FIG. 2, a schematic diagram of a cross sectional view according to the present invention, and a schematic block diagram according to the present invention, are shown therein, respectively. As shown, the electricity generating shoe comprises a shoe body 1, an electricity generating mechanism 2, and a chargeable battery 3.

The electricity mechanism 2 is disposed at a heel portion 13 of the shoe body 1 and driven by the heel portion 13. The electricity generating mechanism 2 comprises a transmission unit 21 connected to the shoe heel 13, a generator 22 connected to the transmission unit 21, a rectifier 23 connected to the generator 22, a switch 24 connected to the rectifier 23, and a connector 25 disposed within the reception area 111 and connected to the switch 24. On the transmission unit 21, a first gear portion 211 and a second gear portion 212 are disposed. The first gear portion 211 is mated with a tooth bar 121, and a driving gear 221 is disposed on the generator 22 to mate with the second gear 212. The chargeable battery 3 is disposed within the reception area 111 of the shoe bottom 11 connected movably to the connector 25 of the electricity generating mechanism 2. The chargeable battery is selected from a group consisting of a lithium chargeable battery, a solid state chargeable battery, and a paper chargeable battery. As such, a novel electricity generating shoe is constituted.

When the present invention is operated, the electricity generating shoe is worn on a foot of a user, and the heel portion 12 is driven to move back and forth when the user walks on the shoe body 1 causing a stamping action, so that the tooth bar 121 on the heel 12 operates together with the first gear portion 211 to rotate the transmission unit 21.

At this time, the transmission unit 21 may drive the generator 2 by using the second gear portion 212 together with the driving gear 221, so that the generator 22 generates an electricity power. The electricity power is relied upon to charge the chargeable battery 3 on the connector 25 through the rectifier 23, and the chargeable battery 3 may be extracted out from the reception area 111 for a user use. In this manner, energy saving and environmental protection purposes may be achieved in addition to a charging without requiring a power.

In addition, when user does not need let the chargeable battery 3 to be charged or no chargeable battery 3 is disposed, the switch 24 may be closed so that the connector 25 may be disconnected with a power source, so as to satisfy the requirement for an actual use.

Referring to FIG. 3, a schematic diagram of a chargeable battery according to another embodiment of the present invention is shown therein. The chargeable battery 3 in the above embodiment may be altered to have another structure, the chargeable battery 3a may be further disposed with a connector 31a. As such, the chargeable battery 31a may be combined together with a portable electronic device (not shown) after being charged to serve together as a mobile power.

In summary, the electricity generating mechanism may be driven by the heel portion of the shoe when a user wears and walks on the shoe, so that the electricity generating mechanism charges the chargeable battery and the efficacies of charging without requiring a power, energy saving and environmental protection may be achieved.

From all these views, the present invention may be deemed as being more effective, practical, useful for the consumer's demand, and thus may meet with the requirements for a patent.

The above described is merely examples and preferred embodiments of the present invention, and not exemplified to intend to limit the present invention. Any modifications and changes without departing from the scope of the spirit of the present invention are deemed as within the scope of the present invention. The scope of the present invention is to be interpreted with the scope as defined in the claims.

What is claimed is:

1. An electricity shoe, comprising:
a shoe body, comprising a shoe bottom, a heel disposed movably on the shoe bottom, and a shoe top-face disposed on a top face of the shoe bottom;
an electricity mechanism, disposed at the heel of the show body and driven by the heel; and
a chargeable battery, disposed within the shoe bottom and connected movably to the electricity generating mechanism.

2. The electricity generating shoe as claimed in claim 1, wherein the heel has a tooth bar connected to the electricity generating mechanism and the shoe bottom has a reception area combined with the chargeable battery.

3. The electricity generating shoe as claimed in claim 2, wherein the electricity mechanism comprises a transmission unit connected to the heel, a generator connected to the transmission unit, a rectifier connected to the generator, a switch connected to the rectifier, and a connector disposed within the reception area and connected to the switch, wherein the chargeable battery is connected movably to the connector.

4. The electricity shoe as claimed in claim 3, wherein the transmission unit has a first gear portion and a second gear portion disposed thereon, wherein the first gear portion is mated with the tooth bar, and a driving gear is disposed on the generator to mate with the second gear portion.

5. The electricity generating shoe as claimed in claim 3, wherein the chargeable battery is selected from a group consisting of a lithium chargeable battery, a solid state chargeable battery, and a paper chargeable battery.

6. The electricity generating shoe as claimed in claim 3, wherein the chargeable battery further has a connector disposed thereon.
